(19) United States
(12) Patent Application Publication
(10) Pub. No.: US 2019/0268160 A1
(43) Pub. Date: Aug. 29, 2019

(54) Method, Mobile Device, Terminal Device and System for Verifying Approval Signature

(71) Applicant: Kmerit (Suzhou) Information Science & Technology Co., Ltd., Suzhou, Jiangsu (CN)

(72) Inventor: Jianghua Meng, Suzhou (CN)

(73) Assignee: Kmerit (Suzhou) Information Science & Technology Co., Ltd., Suzhou, Jiangsu (CN)

(21) Appl. No.: 16/343,708

(22) PCT Filed: Sep. 21, 2017
(86) PCT No.: PCT/CN2017/102567

§ 371 Date: Apr. 19, 2019

(30) Foreign Application Priority Data
Oct. 19, 2016 (CN) 201610907479.6

(51) Int. Cl. H04L 9/32; H04L 9/08; G06F 21/32

(52) U.S. Cl. CPC H04L 9/3231; G06F 21/32; H04L 9/0866

(57) ABSTRACT

The present disclosure relates to the field of communications. Disclosed are a method for verifying an approval signature, a mobile device, a terminal device, and a system using the same. The method includes: encrypting, by a terminal device, approval information with any one of gesture information, a first hand-written signature, first voiceprint information and first fingerprint information from an approver, which are stored in advance; obtaining, by a mobile device, decrypting information input by the approver, and decrypting the encrypted approval information according to the decrypting information; and obtaining, by the mobile device, a signature input by the approver on the approval information after the decryption succeeds, verifying the signature, and sending successful verification information to the terminal device after the signature is successfully verified. The approver may perform the approval with the mobile device which obtains the decrypting information and obtains the signature on the approval information, to improve approval efficiency, which avoids the problems that the others must wait due to an untimely approval when the approver is in a business trip or cannot have convenient access to the terminal device, improving use experience.

### CROSS REFERENCE TO RELATED APPLICATIONS

This is a U.S. National Phase Application under 35 U.S.C. § 371 of International Application No. PCT/CN2017/102567, filed Sep. 21, 2017, which claims priority to Chinese Application No. 201610907479.6, filed Oct. 19, 2017, which was published Under PCT Article 21(2), the entire contents of which are incorporated herein by reference.

### TECHNICAL FIELD

The present disclosure relates to the field of communications, and more particularly, to a method, a mobile device, a terminal device and a system for verifying an approval signature.

### BACKGROUND

At present, many activities in companies or work may relate to a reimbursement process and a reimbursement approval. The approval is generally made by a department leader or a relevant responsible person. However, since the department leader or relevant responsible person cannot perform approval in time due to busy work or business trips, the approval efficiency is not high. Especially, when the reimbursement to be approved is in urgency, problems with regard to delaying work caused by approving untimely may occur often. Therefore, it is needed to provide a method for enabling the department leader or the relevant responsible person to perform an approval in time.

### SUMMARY

To solve the problems in the prior art, embodiments of the present disclosure provide a method, a mobile device, a terminal device and a system for verifying an approval signature. The technical solutions are described as below.

According to a first aspect, provided is a method for verifying an approval signature, which includes:

encrypting, by a terminal device, approval information with any one of gesture information, a first hand-written signature, first voiceprint information and first fingerprint information from an approver, which are stored in advance;

sending, by the terminal device, the encrypted approval information to a mobile device;

receiving, by the mobile device, the approval information, obtaining decrypting information input by the approver, and decrypting the encrypted approval information according to the decrypting information;

obtaining, by the mobile device, a signature input by the approver on the approval information after the decryption succeeds, and verifying the signature; and

sending, by the mobile device, successful verification information to the terminal device after the signature is successfully verified.

In combination with the first aspect, in a first implementable manner, the encrypting the approval information by the terminal device with any one of the gesture information, the first hand-written signature, the first voiceprint information and the first fingerprint information of the approver, which are stored in advance, includes:

extracting key point data that corresponds to the gesture information, the first hand-written signature, the first voiceprint information and the first fingerprint information of the approver respectively; and

encrypting the approval information according to the respectively corresponding key point data.

In combination with the first aspect or the first implementable manner of the first aspect, in a second implementable manner, the sending the encrypted approval information from the terminal device to the mobile device, includes:

recording, by the terminal device, a time point at which the approval information is received;

recording a time duration in which the approval information is not processed, starting from the time point at which the approval information is received;

sending the encrypted approval information to the mobile device, if the time duration is greater than a pre-set time duration; and

not sending the encrypted approval information to the mobile device, if the time duration is not greater than the pre-set time duration.

Means of sending the encrypted approval information from the terminal device to the mobile device include a link, a short messaging service message or a push message.

In combination with the second implementable manner of the first aspect, in a third implementable manner, the obtaining, by the mobile device, the decrypting information input by the approver, and decrypting the encrypted approval information according to the decrypting information, includes:

obtaining, by the mobile device, the gesture information, the first hand-written signature, the first voiceprint information or the first fingerprint information input by the approver used for decryption;

determining whether the input gesture information, the input first hand-written signature, the input first voiceprint information or the input first fingerprint information matches the gesture information, the first hand-written signature, the first voiceprint information or the first fingerprint information of the approver used for decryption respectively;

decrypting the encrypted approval information if matching, and displaying the approval information to the approver; and

not decrypting the encrypted approval information if unmatching.

In connection with the first aspect or the third implementable manner of the first aspect, in a fourth implementable manner, the signature includes a second hand-written signature, a voice signature and a second fingerprint information signature.

In connection with the fourth implementable manner of the first aspect, in the fifth implementable manner, the obtaining the signature input by the approver on the approval information by the mobile device, and verifying the signature, includes:

receiving, by the mobile device, the signature input by the approver;

matching the signature with a pre-stored signature sample in similarity, wherein if a matching result in similarity is greater than or equal to a pre-set similarity, the signature is successfully verified, and prompting information of successful verification is indicated on the mobile device; and

indicating, by the mobile device, prompting information of failed verification, when signature verification fails if the matching result in similarity is less than the pre-set similarity.

The pre-stored signature sample includes a second hand-written signature sample, a voiceprint feature vector sample for voice and a second fingerprint information sample.

In connection with the fifth implementable manner of the first aspect, in a sixth implementable manner, after the mobile device indicates the prompting information of failed verification, the method further includes:

changing, by the approver, a manner for signature verification, to re-input the signature and perform verification.

According to a second aspect, provided is a terminal device. The terminal device includes:

an encrypting module, configured to encrypt approval information with any one of gesture information, a first hand-written signature, first voiceprint information and first fingerprint information from an approver, which are stored in advance;

an encrypted approval information sending module, configured to send the encrypted approval information to a mobile device; and

a successful verification information receiving module, configured to receive successful verification information sent from the mobile device.

In connection with the second aspect, in a first implementable manner, the encrypting module includes:

a key point data extracting sub-module, configured to extract key point data corresponding to the gesture information, the first hand-written signature, the first voiceprint information and the first fingerprint information from the approver respectively; and

an encrypting sub-module, configured to encrypt the approval information according to the respectively corresponding key point data.

In connection with the second aspect or the first implementable manner of the second aspect, in a second implementable manner, the encrypted approval information sending module includes:

an approval information receiving and recording sub-module, configured to record a time point at which the approval information is received;

a unprocessed time duration recording sub-module, configured to record a time duration in which the approval information is not processed, starting from the time point at which the approval information is received;

a time duration determination sub-module, configured to determine whether the time duration is greater than a pre-set time duration; and

an encrypted approval information sending sub-module, configured to send the encrypted approval information to the mobile device when the time duration determination sub-module determines that the time duration is greater than the pre-set time duration.

The encrypted approval information sending sub-module is further configured to not send the encrypted approval information to the mobile device if the time duration is not greater than the pre-set time duration.

Means of sending the encrypted approval information from the terminal device to the mobile device include a link, a short messaging service message or a push message.

According to a third aspect, provided is a mobile device. The device includes:

an approval information receiving module, configured to receive encrypted approval information sent from the terminal device;

a decrypting information obtaining module, configured to obtain decrypting information input by an approver;

a decrypting module, configured to decrypt encrypted approval information according to the decrypting information;

a signature obtaining module, configured to obtain a signature input by the approver on the approval information after the decryption is successfully performed by the decrypting module;

a signature verifying module, configured to verify the signature; and

a successful verification information sending module, configured to send successful verification information to the terminal device after the signature is successfully verified by the signature verifying module.

In connection with the third aspect, in a first implementable manner, the decrypting information obtaining module is specifically configured to obtain the gesture information, the first hand-written signature, the first voiceprint information or the first fingerprint information input by the approver used for decryption.

The decrypting module includes:

a decryption determining sub-module, configured to determine whether the input gesture information, the input first hand-written signature, the input first voiceprint information or the input first fingerprint information matches the gesture information, the first hand-written signature, the first voiceprint information or the first fingerprint information of the approver used for decryption respectively;

a decrypting sub-module, configured to decrypt the encrypted approval information after the decryption determining sub-module determines matching; and

an approval information displaying sub-module, configured to display the approval information to the approver.

The decrypting sub-module is further configured to not decrypt the encrypted approval information after the decryption determining sub-module determines unmatching.

In connection with the third aspect or the first implementable manner of the third aspect, in a second implementable manner, the signature includes a second hand-written signature, a voice signature and a second fingerprint information signature.

In connection with the second implementable manner of the third aspect, in a third implementable manner, the signature obtaining module is specifically configured to receive the signature input by the approver.

The signature verifying module includes:

a verification matching determination sub-module, configured to match the signature with a pre-stored signature sample in similarity;

a signature verifying sub-module, configured to verify the signature successfully when the verification matching determination sub-module determines that a matching result in similarity is greater than or equal to a pre-set similarity; and

a verification indication sub-module, configured to indicate prompting information of successful verification.

The signature verifying sub-module is further configured to determine the signature verification fails when the matching result in similarity is less than the pre-set similarity.

The verification indication sub-module is further configured to indicate prompting information of failed verification;

The pre-stored signature sample includes a second hand-written signature sample, a voiceprint feature vector sample for voice and a second fingerprint information sample.

In connection with the third implementable manner of the third aspect, in a fourth implementable manner, the device further includes:

a verification manner changing module, configured for the approver to change the signature verification manner, to re-input the signature and perform the verification.

According to a fourth aspect, provided is a system for verifying an approval signature. The system includes at least a terminal device and a mobile device.

The terminal device includes:

an encrypting module, configured to encrypt approval information with any one of gesture information, a first hand-written signature, first voiceprint information and first fingerprint information from an approver, which are stored in advance;

an encrypted approval information sending module, configured to send the encrypted approval information to the mobile device; and

a successful verification information receiving module, configured to receive successful verification information sent from the mobile device.

The mobile device includes:

an approval information receiving module, configured to receive approval information sent from the terminal device;

a decrypting information obtaining module, configured to obtain decrypting information input by the approver;

a decrypting module, configured to decrypt encrypted approval information according to the decrypting information;

a signature obtaining module, configured to obtain a signature input by the approver on the approval information after the decryption is successfully performed by the decrypting module;

a signature verifying module, configured to verify the signature; and

a successful verification information sending module, configured to send successful verification information to the terminal device after the signature is successfully verified by the signature verifying module.

In connection with the fourth aspect, in a first implementable manner, the encrypting module includes:

a key point data extracting sub-module, configured to extract key point data corresponding to the gesture information, the first hand-written signature, the first voiceprint information and the first fingerprint information from the approver respectively; and

an encrypting sub-module, configured to encrypt the approval information according to the respectively corresponding key point data.

In connection with the fourth aspect or the first implementable manner of the fourth aspect, in a second implementable manner, the encrypted approval information sending module includes:

an approval information receiving and recording sub-module, configured to record a time point at which the approval information is received;

a unprocessed time duration recording sub-module, configured to record a time duration in which the approval information is not processed, starting from the time point at which the approval information is received;

a time duration determination sub-module, configured to determine whether the time duration is greater than a pre-set time duration; and

an encrypted approval information sending sub-module, configured to send the encrypted approval information to the mobile device when the time duration determination sub-module determines that the time duration is greater than the pre-set time duration.

The encrypted approval information sending sub-module is further configured to not send the encrypted approval information to the mobile device if the time duration is not greater than the pre-set time duration.

Means of sending the encrypted approval information from the terminal device to the mobile device include a link, a short messaging service message or a push message.

In connection with the second implementable manner of the fourth aspect, in a third implementable manner, the decrypting information obtaining module is specifically configured to obtain the gesture information, the first hand-written signature, the first voiceprint information or the first fingerprint information input by the approver used for decryption.

The decrypting module includes:

a decryption determining sub-module, configured to determine whether the input gesture information, the input first hand-written signature, the input first voiceprint information or the input first fingerprint information matches the gesture information, the first hand-written signature, the first voiceprint information or the first fingerprint information of the approver used for decryption respectively;

a decrypting sub-module, configured to decrypt the encrypted approval information after the decryption determining sub-module determines matching; and

an approval information displaying sub-module, configured to display the approval information to the approver.

The decrypting sub-module is further configured to not decrypt the encrypted approval information after the decryption determining sub-module determines unmatching.

In connection with the fourth aspect or the third implementable manner of the fourth aspect, in a fourth implementable manner, the signature includes a second hand-written signature, a voice signature and a second fingerprint information signature.

In connection with the fourth implementable manner of the fourth aspect, in a fifth implementable manner, the signature obtaining module is specifically configured to receive the signature input by the approver.

The signature verifying module includes:

a verification matching determination sub-module, configured to match the signature with a pre-stored signature sample in similarity;

a signature verifying sub-module, configured to verify the signature successfully when the verification matching determination sub-module determines that a matching result in similarity is greater than or equal to a pre-set similarity; and

a verification indication sub-module, configured to indicate prompting information of successful verification;

The signature verifying sub-module is further configured to determine the signature verification fails when the matching result in similarity is less than the pre-set similarity.

The verification indication sub-module is further configured to indicate prompting information of failed verification;

The pre-stored signature sample includes a second hand-written signature sample, a voiceprint feature vector sample for voice and a second fingerprint information sample.

In connection with the fifth implementable manner of the fourth aspect, in a sixth implementable manner, the device further includes:

a verification manner changing module, configured for the approver to change the signature verification manner to re-input the signature and perform the verification.

The technical solutions provided by the embodiments of the present disclosure render following beneficial effects. The approver performs the approval with the mobile device, by which the decrypting information and the signature on the approval information are obtained, whereby the approval efficiency is improved, and the problems that the others must wait due to an untimely approval when the approver is in a business trip or cannot have convenient access to the terminal device are avoided, improving use experience. In addition, the terminal device encrypts the approval information with any one of the gesture information, the first hand-written signature, the first voiceprint information and the first fingerprint information from the approver, that are stored in advance, which improves the security of the approval information while facilitating the approver to perform decryption in any one of the manners after the mobile device receives the approval information, to facilitate the use. In addition, a signature is ensured that is input by the approver himself, by means of obtaining the signature on the approval information input by the approver and verifying the signature after the mobile device is successfully decrypted. Thereby, the security of the approval information is further improved to prevent other people from faking the approver to review the approval information, thereby further improving the approval efficiency. Meanwhile, the mobile device sends successful verification information to the terminal device after the signature is successfully verified, such that the terminal device is capable of obtaining successful approval information timely. Thereby, the successful approval information is fed back to the petitioner timely, avoiding her or him from waiting, which further improves the approval efficiency.

### BRIEF DESCRIPTION OF THE DRAWINGS

In order to describe the technical solutions more clearly according to the embodiments of the present disclosure, the drawings used in the description of the embodiments will be briefly described below. It is obvious that the drawings described below are only some embodiments of the present disclosure. Other drawings may also be obtained from those drawings to those skilled in the art without making any creative efforts.

FIG. 1 is a flow chart diagram illustrating a method for verifying an approval signature provided by an embodiment of the present disclosure.

FIG. 2 is a flow chart diagram illustrating a method for verifying an approval signature provided by an embodiment of the present disclosure.

FIG. 3 is a structural schematic diagram illustrating a terminal device provided by an embodiment of the present disclosure.

FIG. 4 is a structural schematic diagram illustrating a mobile device provided by an embodiment of the present disclosure.

FIG. 5 is a flow chart diagram illustrating a system for verifying an approval signature provided by an embodiment of the present disclosure.

FIG. 6 is a flow chart diagram illustrating a method for verifying an approval signature provided by an embodiment of the present disclosure.

### DETAILED DESCRIPTION OF THE EMBODIMENTS

To make objectives, technical solutions and advantages of the present disclosure clearer, the technical solutions of the embodiments in the present disclosure will be described clearly and completely in combination with the drawings of the embodiments in the present disclosure. Apparently, the described embodiments are merely a portion of the embodiments of the present disclosure, instead of all embodiments. All other embodiments obtained by those skilled in the art based on the embodiments of the present disclosure without any creative efforts are within the scope of the present disclosure.

### Embodiment One

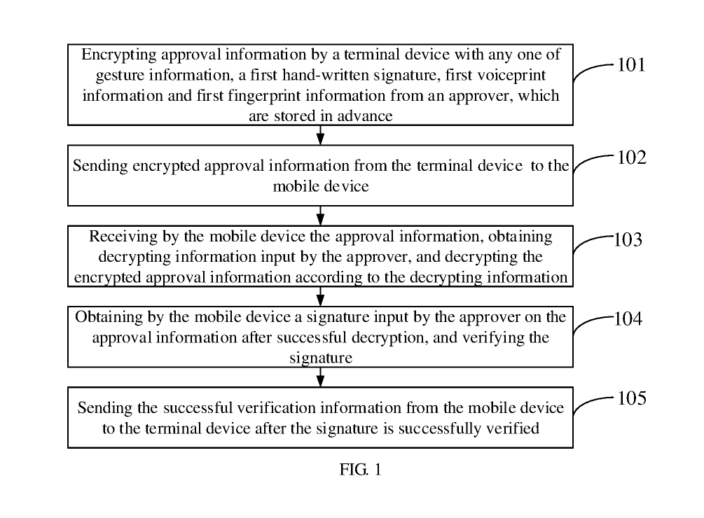

The embodiment of the present disclosure provides a method for verifying an approval signature. Referring to FIG. 1, the method includes following steps.

At the step 101, approval information is encrypted by a terminal device with any one of gesture information, a first hand-written signature, first voiceprint information and first fingerprint information of an approver, which are stored in advance.

Specifically, key point data that corresponds to the gesture information, the first hand-written signature, the first voiceprint information and the first fingerprint information from the approver respectively is extracted.

The approval information is encrypted according to the respectively corresponding key point data.

At the step 102, the encrypted approval information is sent from the terminal device to the mobile device.

The mobile device is a device held by the approver.

Specifically, the encrypted approval information is sent from the terminal device to the mobile device directly.

Optionally, the process of sending the encrypted approval information from the terminal device to the mobile device may further include following steps:

recording in the terminal device a time point at which the approval information is received;

recording a time duration in which the approval information is not processed, starting from the time point at which the approval information is received;

sending the encrypted approval information to the mobile device, if the time duration is greater than a pre-set time duration; and

not sending the encrypted approval information to the mobile device, if the time duration is not greater than the pre-set time duration.

Means of sending the encrypted approval information from the terminal device to the mobile device include a link, a short messaging service (SMS) message, or a push message.

At the step 103, the mobile device receives the approval information, obtains decrypting information input by the approver, and decrypts the encrypted approval information according to the decrypting information.

Specifically, the process of obtaining the decrypting information input by the approver by the mobile device, and decrypting the encrypted approval information, may include:

obtaining the gesture information, the first hand-written signature, the first voiceprint information or the first fingerprint information input by the approver used for decryption, by the mobile device;

determining whether the input gesture information, the input first hand-written signature, the input first voiceprint information or the input first fingerprint information matches the gesture information, the first hand-written signature, the first voiceprint information or the first fingerprint information from the approver used for decryption respectively;

decrypting the encrypted approval information if matching, and displaying the approval information to the approver; and

not decrypting the encrypted approval information, if unmatching.

At the step 104, a signature input by the approver on the approval information is obtained by the mobile device after successful decryption, and the signature is verified.

The signature includes a second hand-written signature, a voice signature and a second fingerprint information signature.

Specifically, the process of obtaining the signature input by the approver on the approval information by the mobile device and verifying the signature, may include:

receiving, by the mobile device, the signature input by the approver;

matching the signature with a pre-stored signature sample in similarity, in which if a matching result in similarity is greater than or equal to a pre-set similarity, the signature is successfully verified and prompting information of successful verification is indicated on the mobile device; and

indicating, by the mobile device, prompting information of failed verification, when signature verification fails if the matching result in similarity is less than the pre-set similarity.

The pre-stored signature sample includes a second hand-written signature sample, a voiceprint feature vector sample for voice and a second fingerprint information sample.

Optionally, after the mobile device indicates the prompting information of failed verification, the method may further include:

changing a manner for verifying the signature by the approver, to re-input the signature and perform the verification step.

At the step 105, the successful verification information is sent from the mobile device to the terminal device after the signature is successfully verified.

The embodiment of the present disclosure provides a method for verifying an approval signature. The approver performs the approval with the mobile device, by which the decrypting information and the signature on the approval information are obtained. Thereby the approval efficiency is improved, and the problems that the others must wait due to an untimely approval when the approver is in a business trip or cannot have convenient access to the terminal device are avoided, improving use experience. In addition, the terminal device encrypts the approval information with any one of the gesture information, the first hand-written signature, the first voiceprint information and the first fingerprint information of the approver, that are stored in advance, which improves the security of the approval information while facilitating the approver to perform decryption in any one of the manners after the mobile device receives the approval information, to facilitate the use. In addition, a signature is ensured that is input by the approver himself, by means of obtaining the signature on the approval information input by the approver and verifying the signature after the mobile device is successfully decrypted. Thereby, the security of the approval information is further improved to prevent other people from spoofing the approver to review the approval information, thereby further improving the approval efficiency. Meanwhile, the mobile device sends successful verification information to the terminal device after the signature is successfully verified, such that the terminal device is capable of obtaining successful approval information timely. Thereby, the successful approval information is fed back to the petitioner timely, avoiding her or him from waiting, which further improves the approval efficiency.

### Embodiment Two

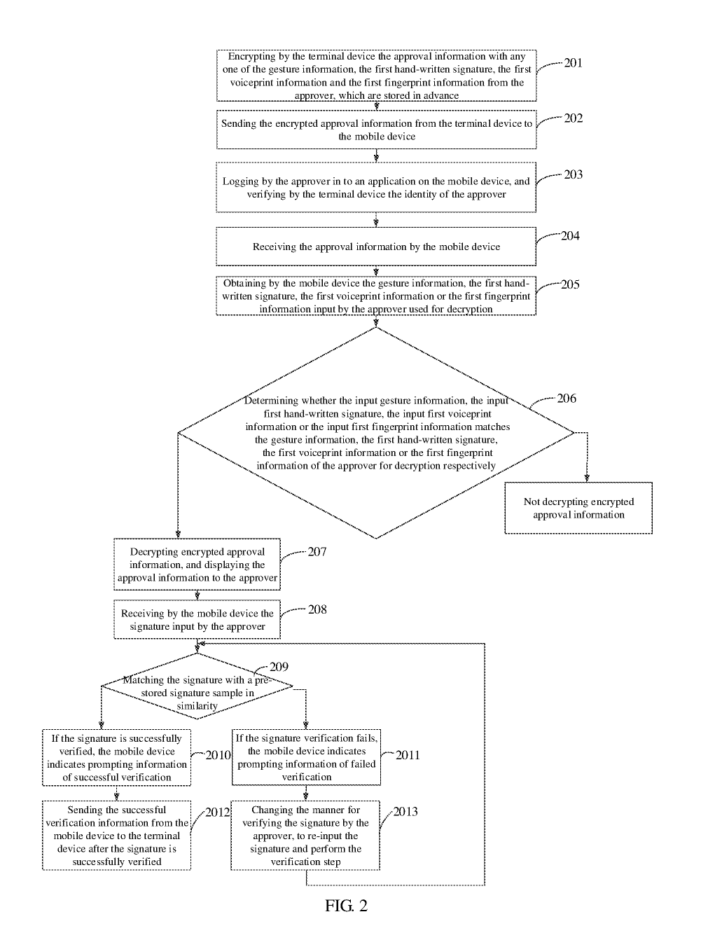

The embodiment of the present disclosure provides a method for verifying an approval signature. Referring to FIG. 2, the method includes following steps.

At the step 201, approval information is encrypted by a terminal device with any one of gesture information, a first hand-written signature, first voiceprint information and first fingerprint information from the approver, which are stored in advance.

Specifically, the process of storing the gesture information, the first hand-written signature, the first voiceprint information and the first fingerprint information from the approver in advance, may include:

logging in, by the approver, to an approving software with a mobile device, inputting at least one of the gesture information, the first hand-written signature, the first voiceprint information and the first fingerprint information via a module with a function of inputting encrypting passwords in the software, and storing the input encrypting passwords.

Optionally, the method may further include:

selecting, by the approver, one of the input encrypting passwords for encryption, or arranging, by the approver, the input encrypting passwords by priority, so as to facilitate the device to select the one with the highest priority as the encrypting password for encryption automatically.

The process of encrypting the approval information by the terminal device with any one of the gesture information, the first hand-written signature, the first voiceprint information and the first fingerprint information from the approver, which are stored in advance, may include following steps.

a. Key point data that corresponds to the gesture information, the first hand-written signature, the first voiceprint information and the first fingerprint information of the approver respectively is extracted.

The gesture information includes any input gesture tracks.

Specifically, extracting the key point data corresponding to the gesture information of the approver includes that the approver inputs the corresponding gesture track, first hand-written signature, or first fingerprint information via input interfaces corresponding respectively to the gesture track, the first hand-written signature and the first fingerprint information in the approving software, and the key point data of the input gesture track, the first hand-written signature and the first fingerprint information of the approver is extracted. The embodiments of the present disclosure do not limit the input interfaces. Meanwhile, the number of the extracted key points is capable of at least uniquely determining the gesture track, the first hand-written signature or the first fingerprint information, which are input by the approver.

Extracting the key point data corresponding to the first voiceprint information of the approver includes that the approver inputs voice section information via a voice input module in the approving software, and key point data of the first voiceprint information of the voice section information input by the approver is extracted. The key point data of the first voiceprint information includes key point information of voiceprint feature vectors.

b. The approval information is encrypted according to the respectively corresponding key point data.

Specifically, the key point data corresponding to the gesture information, the first hand-written signature, the first voiceprint information and the first fingerprint information used for encryption is bonded to the approval information.

At the step 202, the encrypted approval information is sent from the terminal device to the mobile device.

Means of sending the encrypted approval information from the terminal device to the mobile device include a link, a SMS, or a push message.

Specifically, the encrypted approval information is sent from the terminal device directly to the mobile device.

When it is determined that the approver is inconvenient to use the terminal device, after the others submit the approval information, the encrypted approval information is sent to the mobile device of the approver through a corresponding function in the terminal device.

Optionally, the process of sending the encrypted approval information from the terminal device to the mobile device may further include following steps.

a. A time point at which the approval information is received is recorded in the terminal device.

Specifically, the recorded time point at which the approval information is received is the time point at which the information to be approved is submitted through the approving software by the others.

The approval information may be a reimbursement approval, a payment petition or the like. The approval information is not limited in the embodiments of the present disclosure specifically.

b. A time duration starting from the time point at which the approval information is received, in which the approval information is not processed, is recorded.

c. If the time duration is greater than a pre-set time duration, the encrypted approval information is sent to the mobile device; and if the time duration is not greater than the pre-set time duration, the encrypted approval information is not sent to the mobile device.

Specifically, if the time duration is greater than the pre-set time duration, the approval information that is not processed is encrypted, and the encrypted approval information is sent automatically to the mobile device.

When the approval information is not processed for a long time, by recording the time duration in which the approval information is not processed, the approval information may be automatically sent to the mobile device for the approver to perform approval, thereby further improving the approval efficiency and the user experience.

At the step 203, the approver logs in to an application on the mobile device, and the terminal device verifies the identity of the approver.

Specifically, the application may be a program configured to operate the approval information. The embodiments of the present disclosure do not limit the operation mode specifically.

The process of verifying the identity of the approver on the terminal device, may include that:

the mobile device obtains at least one of a login gesture, a login signature, a login voiceprint and a login fingerprint input by the approver, and sends the at least one of the login gesture, the login signature, the login voiceprint and the login fingerprint to the terminal device; and

the terminal device verifies the at least one of the login gesture, the login signature, the login voiceprint and the login fingerprint according to the gesture, signature, voiceprint, and fingerprint, which are stored locally. The verification process may be performed by comparing the login gesture, the login signature, the login voiceprint and the login fingerprint with the gesture, the signature, the voiceprint and the fingerprint stored locally in the terminal device in similarity. The embodiments of the disclosure do not limit the manner for implementing the verification process specifically. In addition to the foregoing verification manner, the verification may be further performed by face identification, or may be further performed in other manners. The verification manner is not limited in the embodiments of the present disclosure specifically.

Optionally, if the approver inputs the login gesture via the mobile device, the approver is then indicated to have to further input at least one of the voiceprint and the fingerprint to complete the verification; or if the approver is inputting the login gesture via the mobile device and the login gesture verification fails, the approver is then indicated to have to further input at least one of the voiceprint and the fingerprint to complete the verification.

If the approver inputs the login signature via the mobile device, the approver is then indicated to have to further input at least one of the voiceprint and the fingerprint to complete the verification; or if the approver is inputting the login signature via the mobile device and the login signature verification fails, the approver is then indicated to have to further input at least one of the voiceprint and the fingerprint to complete the verification.

If the approver inputs the login voiceprint via the mobile device, the approver is then indicated to have to further input the login fingerprint to complete the verification, and if the approver is inputting the login fingerprint via the mobile device, the approver is then indicated to have to further input the login voiceprint to complete the verification.

In practical applications, different verification weights may be set according to the security of the four verification manners of the login gesture, the login signature, the login voiceprint and the login fingerprint. Exemplarily, the verification weight of the login gesture and the login signature may be set to 1, and the verification weight of the login voiceprint and the login fingerprint is set to 2. The system may set the login gesture, the login signature, the login voiceprint, and the login fingerprint into a combination of different verification manners with a verification weight to perform verification according to usage scenarios, data security and user habits. For example, in the scenario where the approval information is only for displaying information, the system may set the verification weight to 2, that is, the approver may complete the verification by completing two verification manners with the verification weight of 1 or completing a verification manner with the verification weight of 2. In the scenario where the approval information is password modification and transaction, the system may set the verification weight to 4, that is, the approver has to complete at least two verification manners, each with the verification weight of 2. According to the security of the approval data, the system may set a minimum of the verification weight to 2, that is, the approver may complete the verification only by completing two verification manners, each with the verification weight of 1, or completing a verification manner with the verification weight of 2 to complete the verification.

The combinations of the above verification weights and verification manners are merely exemplary. In practical applications, the system may further set other verification weights, such as a strong verification, a weak verification or the like. The combinations of the above verification manners are also merely exemplary.

After the verification succeeds, the terminal device sends the gesture information, the first hand-written signature, the first voiceprint information or the first fingerprint information used for decryption to the mobile device. If the terminal device sends the gesture information used for decryption to the mobile device, the terminal device sends a picture or video to the mobile device for indicating the gesture. If the terminal device sends the first hand-written signature to the mobile device, the terminal device sends a picture to the mobile device for indicating the signature. The signature may be a hand-written signature of the approver. The hand-written signature may be any combination of multiple hand-written characters that are stored in the terminal device previously by the approver. If the terminal device sends the first voiceprint information to the mobile device, the terminal device sends a voice prompting information to the mobile device. The voice prompting information is configured to at least describe the voiceprint. The voice prompting information may be any combination of multiple voice characters that are stored in the terminal device previously by the approver. If the terminal device sends the first fingerprint information to the mobile device, the terminal device sends a picture indicating the finger having the fingerprint to the mobile device.

It should be noted that the gesture information, the first hand-written signature, the first voiceprint information or the first fingerprint information used for decryption are only valid during the current login period or for the pre-set time duration. When it is detected that the user has quitted or the time interval from the time point at which the gesture information, the first hand-written signature, the first voiceprint information or the first fingerprint information is sent for decryption last time, is greater than the pre-set time duration, it is determined that the gesture information, the first hand-written signature, the first voiceprint information or the first fingerprint information used for decryption is invalid. In other words, even when the user has inputted the gesture information, the first hand-written signature, the first voiceprint information or the first fingerprint information used for decryption, the decryption cannot be completed.

After the verification fails, the mobile device is locked down for a pre-set time duration, that is, all service requests from the mobile device are ignored. The mobile device is instructed to send location information of the mobile device to the terminal device by a pre-set time interval, and is unlocked after the approver completes offline identity verification. The offline identity verification includes that the approver applies an unlocking procedure to a counter with his or her identity document (such as ID card). The embodiments of the present disclosure do not limit the offline identity verification process specifically.

Since only one of the login gesture, the login signature, the login voiceprint and the login fingerprint is verified, it is possible to result in failure of the verification due to a misinput of the approver or a misidentification of the system. However, verifying at least two of the login gesture, the login signature, the login voiceprint and the login fingerprint not only avoids the misinput of the approver or the misidentification of the system, but also prevents other unauthorized users from completing login and identity verification by means of inputting any one of the login gesture, the login signature, the login voiceprint, the login fingerprint and other manners, thereby improving reliability of the identity verification. In addition, since the gesture information, the first hand-written signature, the first voiceprint information or the first fingerprint information used for decryption is only valid during the current login period or for the pre-set time duration, the reliability and security of keys is improved. In addition, since the mobile device is locked down for the pre-set time duration after the verification fails, unauthorized use of the mobile device by the other unauthorized users is avoided, thereby improving the security and reliability of the approval information.

In addition, the verification described in the embodiment of the present disclosure specifically refers to the identity verification of the approver.

At the step 204, the mobile device receives the approval information.

The embodiments of the present disclosure do not limit specifically the manner in which the mobile device receives the approval information.

At the step 205, the mobile device obtains the gesture information, the first hand-written signature, the first voiceprint information or the first fingerprint information input by the approver used for decryption.

Specifically, when the approver opens the approval information after the mobile device receives the approval information, an interface for inputting a password is displayed to the approver. The interface for inputting a password may be different from one another, which are described specifically as follows.

When it is the gesture information, an interface corresponding to the gesture track input is displayed. When it is the first hand-written signature, an interface with an area for the hand-written signature is displayed. When it is the first voiceprint information, an interface for inputting a voice is displayed. When it is the first fingerprint information, an interface for inputting the fingerprint information is displayed.

At the step 206, it is determined whether the input gesture information, the input first hand-written signature, the input first voiceprint information or the input first fingerprint information matches the gesture information, the first hand-written signature, the first voiceprint information or the first fingerprint information of the approver used for decryption respectively. If matching, steps 207 to 2011 are performed.

If unmatching, the encrypted approval information is not decrypted.

Matching refers to that a matching degree is greater than or equal to a pre-set matching value. Unmatching refers to that the matching degree is less than the pre-set matching value.

At the step 207, the encrypted approval information is decrypted, and the approval information is displayed to the approver.

Specifically, the encrypted approval information is decrypted, and content of the approval information is displayed to the approver.

It should be noted that the steps 206 and 207 are implementation of a process that the mobile device obtains the decrypting information input by the approver, and decrypts the encrypted approval information according to the decrypting information. In addition to the foregoing manner, the process may be implemented also in other manners, and the embodiments of the present disclosure do not limit the manners specifically.

At the step 208, the mobile device receives the signature input by the approver.

The signature includes a second hand-written signature, a voice signature and a second fingerprint information signature.

Specifically, the signature input by the approver is received through a pre-set location of the approval information, or a signing box is popped up after the approver reads the approval information. The approver inputs the signature through the signing box. The signing box may further include an option function button of signing manners, including function buttons corresponding to the second hand-written signature, the voice signature and the second fingerprint information signature respectively. The embodiments of the present disclosure do not limit the function button specifically.

At the step 209, the signature is matched with a pre-stored signature sample in similarity. If a matching result in similarity is greater than or equal to the pre-set similarity, step 2010 is performed. If the matching result in similarity is less than the pre-set similarity, step 2011 is performed.

The pre-stored signature sample includes a second hand-written signature sample, a voiceprint feature vector sample for voice and a second fingerprint information sample.

The process may be described as follows.

The mobile device sends the signature input by the approver to the terminal device.

The terminal device matches the signature with the pre-stored signature sample in similarity.

The terminal device sends the matching result to the mobile device.

Optionally, in practical applications, the signature may be matched with the pre-stored signature sample in similarity according to the process of verifying the identity of the approver in step 203. Taking the example that the verification weight of the login gesture and the login signature is set to 1, and the verification weight of the login voiceprint and the login fingerprint is set to 2 due to the security of the four above-mentioned verification manners of the login gesture, the login signature, the login voiceprint and the login fingerprint, in the scenario where the approval information is only for displaying information and the verification weight in the identity verification of the approver is 2, it is needed only to match any one of the second hand-written signature sample, the voiceprint feature vector sample for voice and the second fingerprint information in similarity in this step. In the scenario where the approval information is password modification and transaction and the verification weight in the process of the identity verification of the approver is 4, it is only needed to match at least two of the second hand-written signature sample, the voiceprint feature vector sample for voice and the second fingerprint information in similarity in this step.

At the step 2010, if the signature is successfully verified, the mobile device indicates the prompting information of successful verification.

Specifically, the prompting information indicating that the verification is successful may be indicated by sound or by text, and may further include other prompting information indicating that the verification is successful by other means. The embodiments of the present disclosure do not limit the manner specifically in which the prompting information is indicated.

At the step 2011, if the signature verification fails, the mobile device indicates the prompting information of failed verification.

Specifically, the prompting information of failed verification may be indicated by sound, by text, by a warning light, a special effect sound and a special effect text, or the like. The embodiments of the present disclosure do not limit the manner of indicating the prompting information of failed verification specifically.

It should be noted that the steps 209 to 2011 are implementation of a process that the mobile device obtains the signature on the approval information input by the approver after the decryption succeeds and verifies the signature. In addition to the foregoing manner, the process may be implemented by other means. The embodiments of the present disclosure do not limit the manner specifically.

After the step 2010, the method further includes a following step.

At the step 2012, the successful verification information is sent from the mobile device to the terminal device after the signature is successfully verified.

The embodiments of the present disclosure do not limit the manner of the step specifically.

After the step 2011, the method further includes a following step.

At the step 2013, the approver changes the manner for verifying the signature, to re-input the signature and to perform the verification step.

Specifically, the approver changes the signature verification manner with the function key in the signing box, to re-enter the signature and perform the steps 209 to 2013.

It should be noted that this step is a loop step, and the number of the re-inputs may be set during use.

It should be noted that the step 2013 is an optional step.

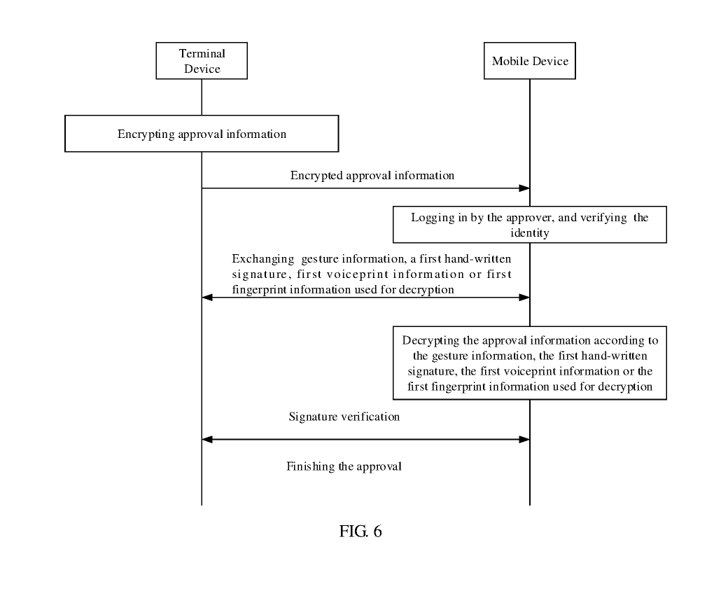

The embodiment of the present disclosure provides a method for verifying an approval signature. The flow chart diagram of the method may refer to FIG. 6. The method encrypts the approval information with the terminal device. After the approver logs in and the identity is successfully verified, the mobile device exchanges the gesture information, the first manual signature, the first voiceprint information or the first fingerprint information used for decryption with the terminal device. The approver decrypts the approval information according to the gesture information, the first hand-written signature, the first voiceprint information or the first fingerprint information used for decryption. The identity verification is achieved by verifying the signature again in the approving process. Thereby, the problems that the others must wait due to an untimely approval when the approver is in a business trip or cannot have convenient access to the terminal device, are avoided, so as to provide the method for verifying the approval information between multiple devices according to different application scenarios, which improves the use experience, the security and the reliability.

The embodiment of the present disclosure provides a method for verifying an approval signature. The approver performs the approval with the mobile device, by which the decrypting information and the signature on the approval information are obtained. Thereby the approval efficiency is improved, and the problems that the others must wait due to an untimely approval when the approver is in a business trip or cannot have convenient access to the terminal device are avoided, improving use experience. In addition, the terminal device encrypts the approval information with any one of the gesture information, the first hand-written signature, the first voiceprint information and the first fingerprint information of the approver, that are stored in advance, which improves the security of the approval information while facilitating the approver to perform decryption in any one of the manners after the mobile device receives the approval information, to facilitate the use. In addition, a signature is ensured that is input by the approver himself, by means of obtaining the signature on the approval information input by the approver and verifying the signature after the mobile device is successfully decrypted. Thereby, the security of the approval information is further improved to prevent other people from spoofing the approver to review the approval information, thereby further improving the approval efficiency. Meanwhile, the mobile device sends successful verification information to the terminal device after the signature is successfully verified, such that the terminal device is capable of obtaining successful approval information timely. Thereby, the successful approval information is fed back to the petitioner timely, avoiding her or him from waiting, which further improves the approval efficiency.

### Embodiment Three

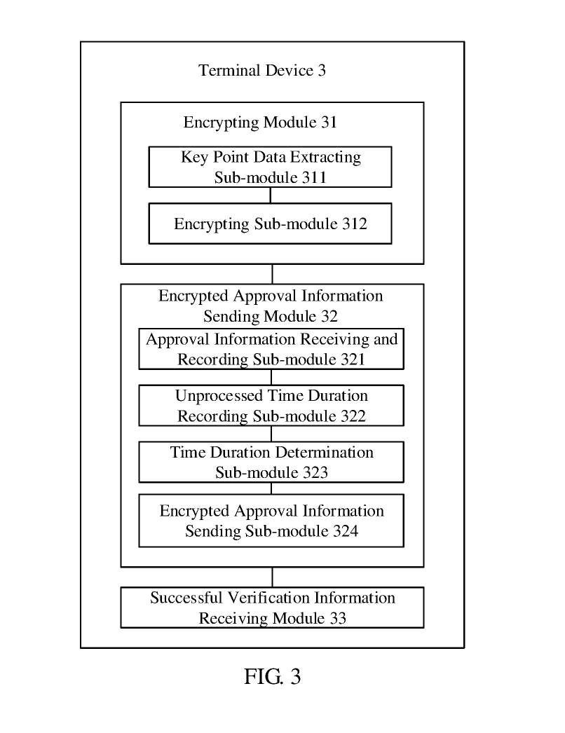

The embodiment of the present disclosure provides a terminal device, which is configured to perform a method for verifying an approval signature. Referring to FIG. 3, the terminal device 3 includes:

an encrypting module 31, configured to encrypt approval information with any one of gesture information, a first hand-written signature, first voiceprint information and first fingerprint information from an approver, which are stored in advance;

an encrypted approval information sending module 32, configured to send the encrypted approval information to the mobile device; and

a successful verification information receiving module 33, configured to receive successful verification information sent from the mobile device.

Optionally, the encrypting module 31 includes:

a key point data extracting sub-module 311, configured to extract key point data corresponding to the gesture information, the first hand-written signature, the first voiceprint information and the first fingerprint information from the approver respectively; and

an encrypting sub-module 312, configured to encrypt the approval information according to the respectively corresponding key point data.

Optionally, the encrypted approval information sending module 32 includes:

an approval information receiving and recording sub-module 321, configured to record a time point at which the approval information is received;

a unprocessed time duration recording sub-module 322, configured to record a time duration in which the approval information is not processed, starting from the time point at which the approval information is received;

a time duration determination sub-module 323, configured to determine whether the time duration is greater than a pre-set time duration; and

an encrypted approval information sending sub-module 324, configured to send the encrypted approval information to the mobile device when the time duration determination sub-module determines that the time duration is greater than the pre-set time duration;

The encrypted approval information sending sub-module 324 is further configured to not send the encrypted approval information to the mobile device if the time duration is not greater than the pre-set time duration;

Means of sending the encrypted approval information from the terminal device to the mobile device include a link, a SMS, or a push message.

The embodiment of the present disclosure provides a terminal device. The terminal device encrypts the approval information with any one of the gesture information, the first hand-written signature, the first voiceprint information and the first fingerprint information of the approver, which are stored in advance, which improves the security of the approval information while facilitating the approver to perform decryption in any one of the manners thereof after the mobile device receives the approval information, to facilitate the use. Meanwhile, the mobile device sends the successful verification information to the terminal device after the signature is successfully verified, such that the terminal device is capable of obtaining successful approval information timely. Thereby, the successful approval information is fed back to the petitioner timely, avoiding her or him from waiting, which further improves the approval efficiency.

### Embodiment Four

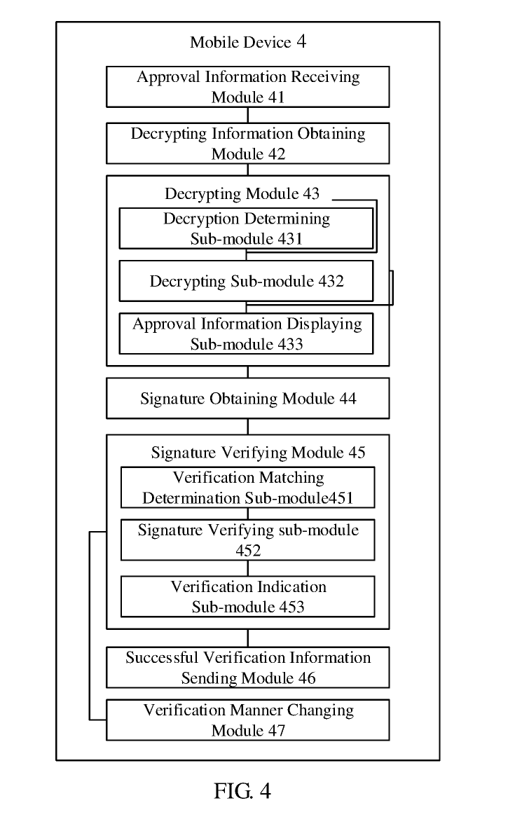

The embodiment of the present disclosure provides a mobile device, which is configured to perform a method for verifying an approval signature. Referring to FIG. 4, the mobile device 4 includes:

an approval information receiving module 41, configured to receive approval information sent from a terminal device;

a decrypting information obtaining module 42, configured to obtain decrypting information input by an approver;

a decrypting module 42, configured to decrypt encrypted approval information according to the decrypting information;

a signature obtaining module 44, configured to obtain a signature input by the approver on the approval information after the decryption is successfully performed by the decrypting module;

a signature verifying module 45, configured to verify the signature; and

a successful verification information sending module 46, configured to send successful verification information to the terminal device after the signature is successfully verified by the signature verifying module.

Optionally, the decrypting information obtaining module 42 is specifically configured to obtain the gesture information, the first hand-written signature, the first voiceprint information or the first fingerprint information input by the approver used for decryption.

The decrypting module 43 includes:

a decryption determining sub-module 431, configured to determine whether the input gesture information, the input first hand-written signature, the input first voiceprint information or the input first fingerprint information matches the gesture information, the first hand-written signature, the first voiceprint information or the first fingerprint information of the approver used for decryption respectively;

a decrypting sub-module 432, configured to decrypt the encrypted approval information after the decryption determining sub-module determines matching; and

an approval information displaying sub-module 433, configured to display the approval information to the approver.

The decrypting sub-module 432 is further configured to not decrypt the encrypted approval information after the decryption determining sub-module determines unmatching.

Optionally, the signature includes the second hand-written signature, the voice signature and the second fingerprint information signature.

Optionally, the signature obtaining module 44 is configured specifically to receive the signature input by the approver.

The signature verifying module 45 includes:

a verification matching determination sub-module 451, configured to match the signature with a pre-stored signature sample in similarity;

a signature verifying sub-module 452, configured to verify the signature successfully when the verification matching determination sub-module determines that a matching result in similarity is greater than or equal to a pre-set similarity; and

a verification indication sub-module 453, configured to indicate prompting information of successful verification;

The signature verifying sub-module 452 is further configured to determine the signature verification fails when the matching result in similarity is less than the pre-set similarity.

The verification indication sub-module 453 is further configured to indicate prompting information of failed verification;

The pre-stored signature sample includes a second hand-written signature sample, a voiceprint feature vector sample for voice and a second fingerprint information sample.

Optionally, the device further includes:

a verification manner changing module 47, configured for the approver to change the signature verification manner to re-input the signature and perform the verification.

The embodiment of the present disclosure provides a mobile device. The approver performs the approval with the mobile device, by which the decrypting information and the signature on the approval information are obtained. Thereby the approval efficiency is improved, and the problems that the others must wait due to an untimely approval when the approver is in a business trip or cannot have convenient access to the terminal device are avoided, improving the use experience. In addition, the terminal device encrypts the approval information with any one of the gesture information, the first hand-written signature, the first voiceprint information and the first fingerprint information of the approver, that are stored in advance, which improves the security of the approval information while facilitating the approver to perform decryption in any one of the manners after the mobile device receives the approval information, to facilitate the use. In addition, a signature is ensured that is input by the approver himself, by means of obtaining the signature on the approval information input by the approver and verifying the signature after the mobile device is successfully decrypted. Thereby, the security of the approval information is further improved to prevent other people from spoofing the approver to review the approval information, thereby further improving the approval efficiency. Meanwhile, the mobile device sends successful verification information to the terminal device after the signature is successfully verified, such that the terminal device is capable of obtaining successful approval information timely. Thereby, the successful approval information is fed back to the petitioner timely, avoiding her or him from waiting, which further improves the approval efficiency.

### Embodiment Five

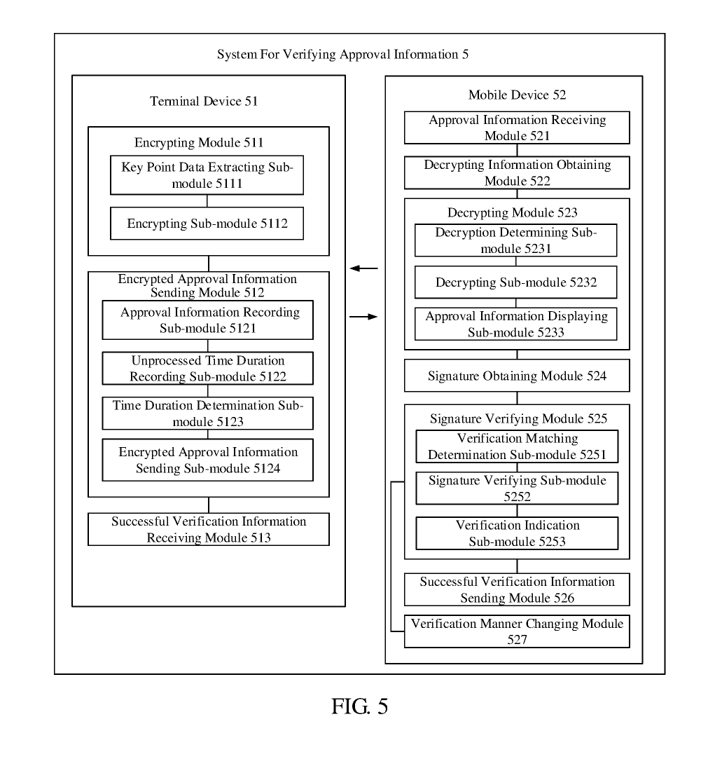

The embodiment of the present disclosure provides a system for verifying an approval signature. Referring to FIG. 5, the system 5 includes at least a terminal device 51 and a mobile device 52.

The terminal device 51 includes:

an encrypting module 511, configured to encrypt approval information with any one of gesture information, a first hand-written signature, first voiceprint information and first fingerprint information from the approver, which are stored in advance;

an encrypted approval information sending module 512, configured to send the encrypted approval information to the mobile device; and

a successful verification information receiving module 513, configured to receive successful verification information sent from the mobile device.

The mobile device 52 includes:

an approval information receiving module 521, configured to receive the approval information sent from a terminal device;

a decrypting information obtaining module 522, configured to obtain decrypting information input by the approver;

a decrypting module 523, configured to decrypt the encrypted approval information according to the decrypting information;

a signature obtaining module 524, configured to obtain a signature input by the approver on the approval information after the decryption is successfully performed by the decrypting module;

a signature verifying module 525, configured to verify the signature; and

a successful verification information sending module 526, configured to send successful verification information to the terminal device after the signature is successfully verified by the signature verifying module.

Optionally, the encrypting module 511 includes:

a key point data extracting sub-module 5111, configured to extract key point data corresponding respectively to the gesture information, the first hand-written signature, the first voiceprint information and the first fingerprint information from the approver; and

an encrypting sub-module 5112, configured to encrypt the approval information according to the respectively corresponding key point data.

Optionally, the encrypted approval information sending module 512 includes:

an approval information receiving and recording sub-module 5121, configured to record a time point at which the approval information is received;

a unprocessed time duration recording sub-module 5122, configured to record a time duration in which the approval information is not processed, starting from the time point at which the approval information is received;

a time duration determination sub-module 5123, configured to determine whether the time duration is greater than a pre-set time duration; and

an encrypted approval information sending sub-module 5124, configured to send the encrypted approval information to the mobile device when the time duration determination sub-module determines that the time duration is greater than the pre-set time duration.

The encrypted approval information sending sub-module 5124 is further configured to not send the encrypted approval information to the mobile device if the time duration is not greater than the pre-set time duration;

Means of sending the encrypted approval information from the terminal device to the mobile device include a link, a SMS, or a push message.

Optionally, the decrypting information obtaining module 522 is specifically configured to obtain the gesture information, the first hand-written signature, the first voiceprint information or the first fingerprint information input by the approver used for decryption.

The decrypting module 523 includes:

a decryption determining sub-module 5231, configured to determine whether the input gesture information, the input first hand-written signature, the input first voiceprint information or the input first fingerprint information matches the gesture information, the first hand-written signature, the first voiceprint information or the first fingerprint information of the approver used for decryption respectively;

a decrypting sub-module 5232, configured to decrypt the encrypted approval information after the decryption determining sub-module determines matching; and

an approval information displaying sub-module 5233, configured to display the approval information to the approver.

The decrypting sub-module 5232 is further configured to not decrypt the encrypted approval information after the decryption determining sub-module determines unmatching.

Optionally, the signature includes the second hand-written signature, the voice signature and the second fingerprint information signature.

Optionally, the signature obtaining module 524 is configured specifically to receive the signature input by the approver.

The signature verifying module 525 includes:

a verification matching determination sub-module 5251, configured to match the signature with a pre-stored signature sample in similarity;

a signature verifying sub-module 5252, configured to verify the signature successfully when the verification matching determination sub-module determines that a matching result in similarity is greater than or equal to a pre-set similarity; and

a verification indication sub-module 5253, configured to indicate prompting information of successful verification;

The signature verifying sub-module 5252 is further configured to determine the signature verification fails when the matching result in similarity is less than the pre-set similarity.

The verification indication sub-module 5253 is further configured to indicate prompting information of failed verification;

The pre-stored signature sample includes a second hand-written signature sample, a voiceprint feature vector sample for voice and a second fingerprint information sample.

Optionally, the mobile device 52 further includes:

a verification manner changing module 527, configured for the approver to change the signature verification manner to re-input the signature and perform the verification.

The embodiment of the present disclosure provides a system for verifying an approval signature. The approver performs the approval with the mobile device, by which the decrypting information and the signature on the approval information are obtained. Thereby the approval efficiency is improved, and the problems that the others must wait due to an untimely approval when the approver is in a business trip or cannot have convenient access to the terminal device are avoided, improving use experience. In addition, the terminal device encrypts the approval information with any one of the gesture information, the first hand-written signature, the first voiceprint information and the first fingerprint information of the approver, that are stored in advance, which improves the security of the approval information while facilitating the approver to perform decryption in any one of the manners after the mobile device receives the approval information, to facilitate the use. In addition, a signature is ensured that is input by the approver himself, by means of obtaining the signature on the approval information input by the approver and verifying the signature after the mobile device is successfully decrypted. Thereby, the security of the approval information is further improved to prevent other people from spoofing the approver to review the approval information, thereby further improving the approval efficiency. Meanwhile, the mobile device sends successful verification information to the terminal device after the signature is successfully verified, such that the terminal device is capable of obtaining successful approval information timely. Thereby, the successful approval information is fed back to the petitioner timely, avoiding her or him from waiting, which further improves the approval efficiency.

All the above optional technical solutions may be combined arbitrarily to form an optional embodiment of the present disclosure, and will not be further described in detail hereto. The “first” and “second” described in the above embodiments are only for distinguishing, and are not specifically limiting hereto. In addition, in practical applications, the terminal device in the embodiment of the present disclosure may be a server, or may be also a server farm composed of a plurality of servers, or may also be a computer terminal, which is not limited in the embodiments of the present disclosure. The mobile device may be a smart phone, or may also be a dedicated device for implementing the method of the present disclosure, or may also be a tablet computer, which is not limited in the embodiments of the present disclosure.

It should be noted that the processes of the method for verifying an approval signature performed by the terminal device, the mobile device and the system for verifying the approval signature provided by the foregoing embodiments are illustrated according to the division of all the above function modules. In practical applications, the above functions may be assigned to different function modules according to requirements, that is, the internal configuration of each of the terminal device, the mobile device and the system for verifying the approval signature is divided into different function modules, to perform the whole or part of the functions described above. In addition, the terminal device, the mobile device, and the system for verifying the approval signature provided by the foregoing embodiments are in the same concept as the embodiments of the method for verifying the approval signature, and the specific implementation process is described in the method embodiments, which is not described in detail hereto.

A person skilled in the art may understand that the whole or part of the steps of implementing the above embodiments may be performed by hardware, or may be performed by related hardware instructed by a program. The program may be stored in a computer readable storage medium. The storage medium may be a read only memory, a magnetic disk, an optical disk, or the like.

The above embodiments are only preferred embodiments of the present disclosure, and are not intended to limit the present disclosure. Any modifications, equivalents, improvements and the like, which fall within the spirit and scope of the present disclosure, should be included within the protection scope of the present invention.

1. A method for verifying an approval signature, comprising:
encrypting, by a terminal device, approval information with any one of gesture information, a first hand-written signature, first voiceprint information and first fingerprint information from an approver, which are stored in advance;
sending, by the terminal device, the encrypted approval information to a mobile device;
receiving, by the mobile device, the approval information, obtaining decrypting information input by the approver, and decrypting the encrypted approval information according to the decrypting information;
obtaining, by the mobile device, a signature input by the approver on the approval information after the decryption succeeds, and verifying the signature; and
sending, by the mobile device, successful verification information to the terminal device after the signature is successfully verified.

2. The method of claim 1, wherein the encrypting, by the terminal device, the approval information with any one of the gesture information, the first hand-written signature, the first voiceprint information and the first fingerprint information from the approver, which are stored in advance, comprises:
extracting key point data that corresponds to the gesture information, the first hand-written signature, the first voiceprint information and the first fingerprint information of the approver respectively; and
encrypting the approval information according to the respectively corresponding key point data.

3. The method of claim 1, wherein the sending, by the terminal device, the encrypted approval information to the mobile device, comprises:
recording, by the terminal device, a time point at which the approval information is received;
recording a time duration in which the approval information is not processed, starting from the time point at which the approval information is received;
sending the encrypted approval information to the mobile device, if the time duration is greater than a pre-set time duration; and
not sending the encrypted approval information to the mobile device, if the time duration is not greater than the pre-set time duration,
wherein means of sending the encrypted approval information from the terminal device to the mobile device comprise a link, a short messaging service message or a push message.

4. The method of claim 3, wherein the obtaining, by the mobile device, the decrypting information input by the approver, and decrypting the encrypted approval information according to the decrypting information, comprises:
obtaining, by the mobile device, the gesture information, the first hand-written signature, the first voiceprint information or the first fingerprint information input by the approver used for decryption;
determining whether the input gesture information, the input first hand-written signature, the input first voiceprint information or the input first fingerprint information matches the gesture information, the first hand-written signature, the first voiceprint information or the first fingerprint information from the approver used for decryption respectively;
decrypting the encrypted approval information if matching, and displaying the approval information to the approver; and
not decrypting the encrypted approval information if unmatching.

5. The method of claim 1, wherein the signature comprises a second hand-written signature, a voice signature and a second fingerprint information signature.

6. The method of claim 5, wherein the obtaining, by the mobile device, the signature input by the approver on the approval information, and verifying the signature, comprises:
receiving, by the mobile device, the signature input by the approver;
matching the signature with a pre-stored signature sample in similarity, wherein if a matching result in similarity is greater than or equal to a pre-set similarity, the signature is successfully verified, and prompting information of successful verification is indicated on the mobile device; and
indicating, by the mobile device, prompting information of failed verification, when signature verification fails if the matching result in similarity is less than the pre-set similarity,
wherein the pre-stored signature sample comprises a second hand-written signature sample, a voiceprint feature vector sample for voice and a second fingerprint information sample.

7. The method of claim 6, wherein after the mobile device indicates the prompting information of the failed verification, the method further comprises:
changing, by the approver, a manner for the signature verification, to re-input the signature and perform verification.

8. A terminal device, comprising:
an encrypting module, configured to encrypt approval information with any one of gesture information, a first hand-written signature, first voiceprint information and first fingerprint information of the approver, which are stored in advance;
an encrypted approval information sending module, configured to send the encrypted approval information to a mobile device; and
a successful verification information receiving module, configured to receive successful verification information sent from the mobile device.

9. A mobile device, comprising:
an approval information receiving module, configured to receive encrypted approval information sent from a terminal device;
a decrypting information obtaining module, configured to obtain decrypting information input by an approver;
a decrypting module, configured to decrypt the encrypted approval information according to the decrypting information;
a signature obtaining module, configured to obtain a signature input by the approver on the approval information after the decryption is successfully performed by the decrypting module;
a signature verifying module, configured to verify the signature; and
a successful verification information sending module, configured to send successful verification information to the terminal device after the signature is successfully verified by the signature verifying module.

10. (canceled)
